(19) United States
(12) Patent Application Publication
(10) Pub. No.: US 2003/0030186 A1
(43) Pub. Date: Feb. 13, 2003

(54) Sprueless hydrostatic injection molding

(76) Inventors: Matthew T. Riiska, Norfolk, CT (US); William J. Washburn, Canaan, CT (US); Don Ernst, Canaan, CT (US); Andrew G. Summerville JR., Goshen, CT (US); C. Robin Hwang, Cary, NC (US); Frank E. Martin, Durham, NC (US)

Correspondence Address: BECTON, DICKINSON AND COMPANY, 1 BECTON DRIVE, FRANKLIN LAKES, NJ, 07417-1880, US

(21) Appl. No.: 10/256,888

(22) Filed: Sep. 27, 2002

Related U.S. Application Data
(63) Continuation of application No. 09/561,677, filed on May 1, 2000, now abandoned.

(51) Int. Cl. B29C 45/00

(52) U.S. Cl. 264/328.4; 425/544; 425/556

(57) ABSTRACT

A hydrostatic injection molding apparatus and process are provided for thermoplastic materials, especially thermoplastic elastomers. The apparatus includes a hot pot plate with a transfer chamber for receiving a thermoplastic material. The hot pot plate is heated to maintain the thermoplastic material in the transfer chamber in a molten state. A cavity plate is positioned adjacent the transfer pot plate, the cavity plate is formed with a plurality of cavities extending therein. Gates are formed in the hot pot plate and the cavity plate. The gates in the respective plates register with one another to provide communication between the transfer chamber and the cavities. The cavity plate is cooled to enable a rapid curing of the thermoplastic material therein.

### CROSS-REFERENCE TO RELATED APPLICATIONS

The present application is a continuation of U.S. patent application Ser. No. 09/561,677 filed on May 1, 2000.

### BACKGROUND OF THE INVENTION

The subject invention relates to molding small parts with thermoplastic materials especially thermoplastic elastomers and method for molding small thermoplastic elastomer parts without complex arrays of runners and sprue plates for the reduction of scrap or waster of materials. In particular, the subject invention relates to an apparatus and method for molding syringe stoppers or tube stoppers from a thermoplastic material.

Many small injected molded parts are used in the medical industry. For example, in specimen collection tubes the open end of the tube is sealed with an elastomeric stopper for isolating a material stored in the tube or for maintaining a vacuum in the specimen collection tube.

Small molded parts also are used with prior art hypodermic syringes. In particular, the prior art hypodermic syringe has a barrel with a narrowly opened distal end, a widely opened proximal end and a cylindrical chamber extending therebetween. The widely open proximal end of the prior art syringe barrel is sealed with an elastomeric stopper. The stopper of the prior art syringe barrel may be mounted to a piston that can be used to slide the stopper in the syringe barrel. Distal movement of the piston and stopper urges a fluid from the chamber and through the passage at the distal end of the syringe barrel. Similarly, proximal movement of the piston and stopper draws a fluid through the passage and into the chamber of the syringe barrel.

The stoppers for tubes and syringe barrels typically are formed from rubber and typically are made by compression molding or transfer molding. Compression molding involves placing rubber pellets or sheets inside the mold. Pressure then is applied to the rubber in the mold, and causes the rubber to conform to the shape of the mold. Excess rubber then must be trimmed from the finished part. This trimming process complicates the manufacturing process and necessitates excess work to dispose of the waste and ensure that the finished part is free of debris.

Transfer molding for rubber components involves a stacked array of three mold plates. The upper plate defines a pot for receiving the rubber to be molded. The middle layer includes a plurality of channels or runners that communicate with the pot of rubber. The lower plate includes mold cavities that align with the runners and receive the rubber urged from the pot and through the runners. Some prior art transfer mold systems heat all three mold plates sufficiently to keep the rubber in the pot in a molten state. The rubber in the pot then is subjected to high pressure which urges the rubber through the runners and into the cavities. The rubber in all three layers then is cured. The cured rubber in the old cavities can be separated from the runners to produce parts that require little or no trimming. However, the remaining rubber in the pot and in the channels also is cured, and represents a substantial volume of waste that must be processed. U.S. Pat. No. 3,876,356 relates to a cold transfer molding apparatus for rubber. The apparatus and process disclosed in this patent keeps the transfer pot cold to prevent vulcanization of rubber in the pot at the end of a mold cycle. The cavity plate, however, is hot. As a result, at the end of the molding cycle, only the rubber in the cavity and part of the rubber in the channels will be cured. This prior art process will produce a much lower volume of waste rubber. Furthermore, it is possible to control the temperatures to achieve a sharp temperature gradient across the runner plate between the transfer pot and the mold cavities so that a consistent tear-off of the runners will occur at the periphery of the mold cavities.

Thermoplastic elastomers have been used for very large syringes, such as 60 cc syringes. These thermoplastic elastomer stoppers have been molded with a hot runner injection mold. However, injection molding with a hot runner mold is expensive and is not cost-effective for producing small thermoplastic elastomer parts due to the limited cavitation enabled by this technology. More particularly, the required heating of the cavity plate substantially reduces the density of mold cavities, thereby producing relatively few stoppers per mold cycle. Attempts have been made to injection mold small thermoplastic elastomeric components with a cold or semi-hot runner system. However, the injection molding of small thermoplastic elastomeric parts produces huge amounts of waste, with the weight of the waste being almost twenty times the weight of the actual parts.

### SUMMARY OF THE INVENTION

The subject invention relates to a hydrostatic injection molding apparatus and method for molding syringe stoppers or tube stoppers from a thermoplastic material, in particular a thermoplastic elastomer. The apparatus includes a hot transfer pot and a cooled cavity block disposed in abutting face-to-face engagement with one another. The hot transfer pot includes a transfer chamber for receiving a molten thermoplastic material. The transfer pot is formed with a plurality of apertures for receiving heater cartridges that heat the transfer pot sufficiently to maintain the thermoplastic elastomer in a molten state. A plurality of transfer gates extend through the hot transfer pot from the transfer chamber to a surface of the hot transfer pot that mates with the cooled cavity block. The hot transfer pot further includes means for injecting the molten thermoplastic elastomer from the transfer chamber through the transfer gates and into the cavities of the cavity block as explained herein. The means for injecting the molten thermoplastic elastomer may be a machine clamp that is selectively activated to exert forces on the molten thermoplastic elastomer sufficient for urging the molten thermoplastic elastomer through the gates at a selected speed. The machine clamp also may be heated to ensure a substantially uniform temperature of the molten thermoplastic elastomer throughout the hot transfer pot.

The cooled cavity block includes a mating surface in face-to-face mating engagement with the mating surface of the hot transfer pot. The cavity block further includes a plurality of cavities formed therein with shapes and sizes that correspond to the specified shape and size for the molded stopper or other such molded product. The cavity block further includes a plurality of cavity gates formed therein. The cavity gates extend from the respective mold cavities to locations that register with corresponding transfer gates of the hot transfer pot. Thus, a flow of the molten thermoplastic elastomer can be directed from the transfer chamber of the hot transfer pot through the registered gates and into the respective mold cavities.

The cavity block is cooled sufficiently to cause the molten thermoplastic elastomer to freeze or solidify. The lengths and cross-sectional shapes of the gates are selected to keep the contact between the hot transfer gate and the cooled cavity block small and to allow the thermoplastic elastomer to freeze off at the gate area. The small gates effectively increase shear and reduce viscosity. The small gate size achieves a very rapid flow of material into the mold cavities, and thus maximizes shear and minimizes viscosity. After the thermoplastic elastomer in the molt cavities has frozen or solidified, the mold is opened and the molded parts are removed.

The molding apparatus of the subject invention and the corresponding process achieves a very small amount of waste. More particularly, the waste is limited to any small amounts of thermoplastic elastomeric material which may be left in a semi-solid state in the gate. This material will be softened during the next molding cycle and will be compressed through the gate from the hot pot and into the mold cavity with the next shot of molten thermoplastic elastomer. Thus, this remaining small plug of thermoplastic elastomer will become part of a unitary matrix of thermoplastic elastomers that will be received in the respective cavity during the next molding cycle.

The molding apparatus of the subject invention eliminates sprue plates and eliminates complex runners that had been used in prior art molding apparatus, and particularly prior art molding apparatus intended for rubber. As a result, the mold is of relatively simple design, and is relatively inexpensive to manufacture. Furthermore, the complete absence of a sprue plate substantially minimizes costs and simplifies designs. Furthermore, the absence of runners and sprues enables a greater cavitation, which is a higher density of cavities.

In certain embodiments, a freeze of the gate can create problems. In these embodiments, a blade could be incorporated into the cavity block or between the cavity block and the transfer hot pot. The blades may be hydraulically operated and may function to mechanically shut off the gate.

### BRIEF DESCRIPTION OF THE DRAWINGS

FIG. 1 is an exploded front elevational view, partly in section, of a hydrostatic injection mold apparatus for thermoplastic elastomers in accordance with the subject invention.

FIG. 2 is an assembled front elevational view of the apparatus, partly in section.

FIG. 3 is a cross-sectional view taken along line 3-3 in FIG. 2.

FIG. 4 is an enlarged side elevational view of the gate area at the interface of the hot transfer pot and the cooled mold cavity block.\

FIG. 5 is a cross-sectional view of an alternate mold cavity and gate.

### DETAILED DESCRIPTION

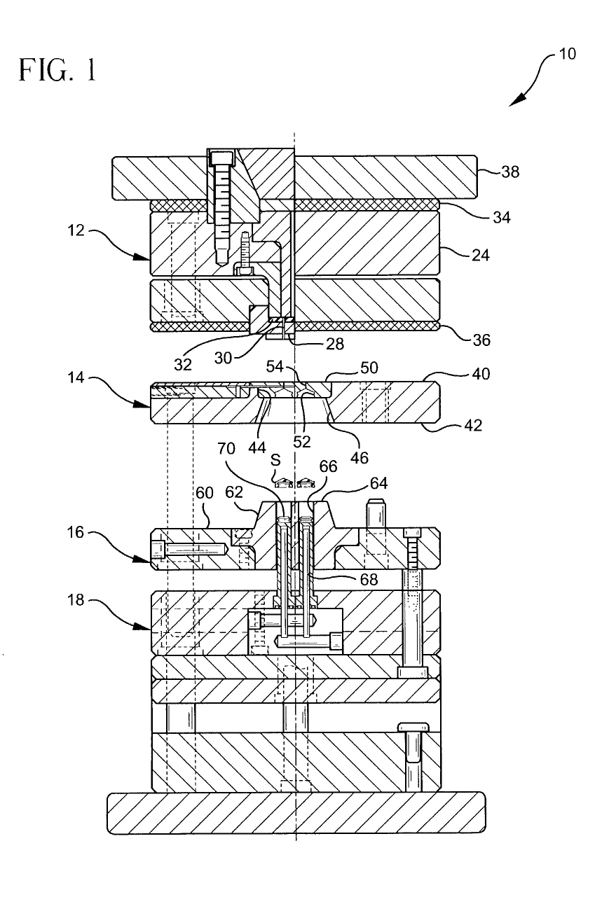

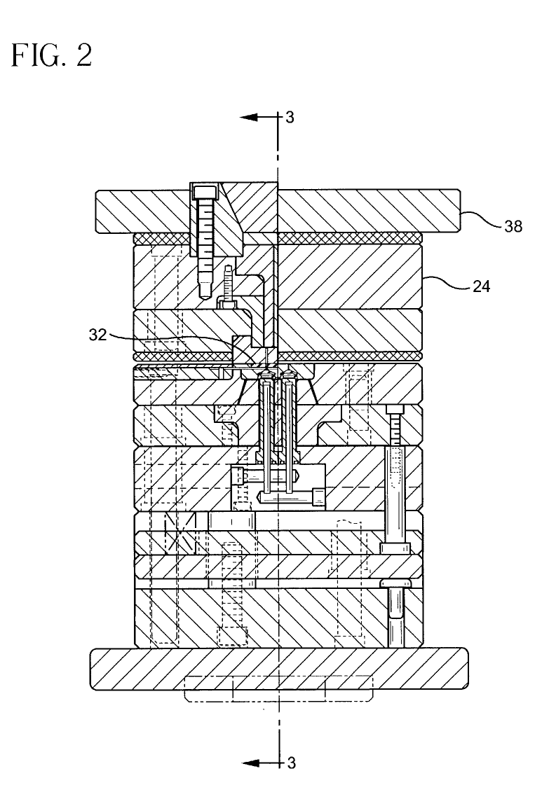

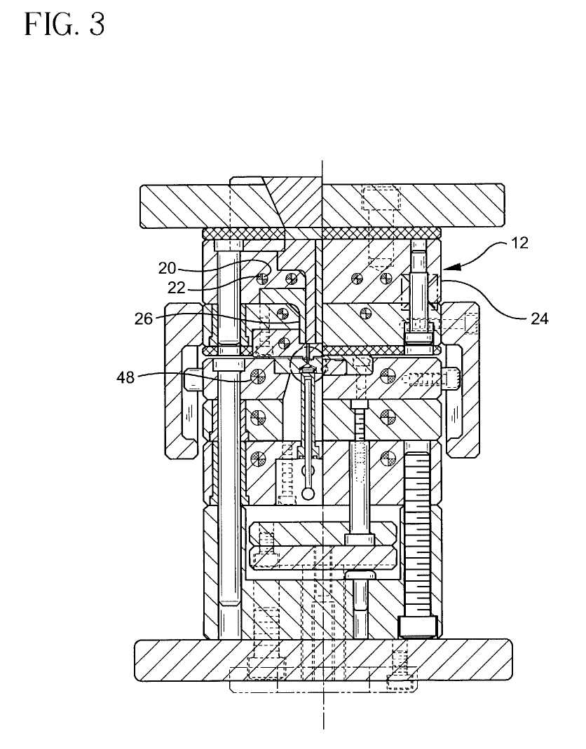

A molding apparatus in accordance with the subject invention is identified generally by the numeral 10 in FIGS. 1-4. Molding apparatus 10 includes a hot transfer plate assembly 12, a cavity plate 14, a stripper plate 16 and a support plate assembly 18. Hot transfer plate assembly 12 is formed with a plurality of apertures 20 therein as shown most clearly in FIG. 3. Apertures 20 in hot plate assembly 12 are configured to receive heating cartridges 22 for heating the components of hot transfer plate assembly 12 sufficiently for maintaining a thermoplastic material therein in a molten state. Preferably, the thermoplastic material is a thermoplastic elastomer. However, it is within the scope of the present invention to use any thermoplastic material known to those skilled in the art. Hot transfer plate assembly 12 further includes a clamp plate 24 and a hot pot transfer plate 26. Hot pot transfer plate 26 includes a cavity mating face 28 in opposed facing relationship to cavity plate 14. Face 28 is the only contact to the cavity insert. This minimum contact is important to reduce thermal transfer from the hot pot transfer plate to the cavity which is cooled. Narrow gates 30 extend through hot pot transfer plate 26 from mating face 28 to a hot pot 32. Clamp plate 24 is operative to exert a selected pressure on a molten thermoplastic elastomer in hot pot 32 for urging a shot of the molten thermoplastic elastomer from hot pot 32, through gates 30 and toward cavity plate 14. Hot plate assembly 12 further includes insulating sheets 34 and 36. Insulating sheet 34 is adjacent the side of clamp plate 24 facing away from the hot pot plate 26, while insulating sheet 36 is disposed between hot pot plate 26 and cavity plate 14. Insulating sheets 34 and 36 function to substantially isolate the heat of hot plate assembly 12 within clamp plate 24 and hot pot transfer plate 26. Specifically, insulation sheet 36 reduces heat transfer between hot pot transfer plate 26 and cavity plate 14.

The hot plate assembly 12 further includes an adaptor plate 38 secured over the insulation sheet 34 for substantially covering and enclosing the hot plate assembly 12 and isolating the heated clamp plate 24 and the hot pot transfer plate 26 from the surrounding environment.

The cavity plate 14 includes a transfer plate mating surface 40 and an opposite stripper plate mating surface 42. There is minimal contact between hot pot 32 and cavity insert 50 to reduce the amount of thermal transfer to keep heat away from the cavity insert block. An insert cavity 44 extends into the transfer plate mating surface 42, and a stripper plate cavity 46 extends sufficiently into stripper plate mating surface 42 for communicating with insert cavity 44. A plurality of cooling channels 48 extend through cavity plate 14 at locations in proximity to insert cavity 44. Cooling channels 48 accommodate a flow of cooling fluid, such as cooling water, for maintaining cavity plate 14 at a sufficiently cool temperature to freeze or solidify the molten thermoplastic elastomer that enters the cavities as explained herein.

Cavity plate 14 further includes a cavity insert 50 positioned in the insert seat 44. Cavity insert 50 is formed with a plurality of cavities 52 each of which has a selected configuration conforming to the required shape for the stopper or other small thermoplastic elastomeric part to be molded by apparatus 10. Cavities 52 formed in cavity insert 50 to open downwardly and toward the stripper recess 46. Cavity insert 50 further includes a plurality of cavity gates 54 that extend a short distance from the respective cavities 52 to the surface of cavity insert 50 that faces hot transfer plate assembly 12. In the embodiment shown herein, gates 54 are disposed to enter a central location on the respective cavities 52. Additionally, cavities 52 and cavity gates 54 are disposed to register with the hot pot gates 30.

Stripper plate 16 includes a cavity mating surface 60 configured to mate with stripper plate mating surface 42 of cavity plate 14. Stripper plate 16 further includes a stripper projection 62 configured to nest with stripper plate recess 46 of cavity plate 14. Stripper projection 62 includes an insert mating face 64 disposed and configured to mate with the cavity insert 50 of the cavity plate 14. Insert mating surface 64 functions to at least partly close cavities 52 in cavity insert 50. Stripper plate 16 further includes a plurality of stripper channels 66 disposed to register with the respective cavities 52 of cavity insert 50. Stripper rods 68 are positioned slidably in stripper channels 66 and are hydraulically powered to move axially in stripper channels 66. Stripper rods 68 include cavity mounting ends 70 that are of a non-cylindrical and preferably undercut stepped configuration. Each stripper rod 68 is operative to advance between an extended position in which stripping ends 70 extend into the respective cavities 52 of cavity insert 50 and a retracted position where stripping ends 70 are spaced from the cavities 52. The molten thermoplastic elastomer will flow around stripping ends 70 of the stripper rods 68 when stripper rods 68 are in their extended position, such that each stripping end 70 lies within one of the respective stopper S. Movement of stripper plate 16 and stripper rods 68 relative to cavity plate 14 will cause stripper rods 68 to pull molded stoppers S from the cavities 52. Subsequently, a movement of stripper rods 68 into a retracted position relative to stripper plate 16 will separate molded stoppers S from stripper rods 68.

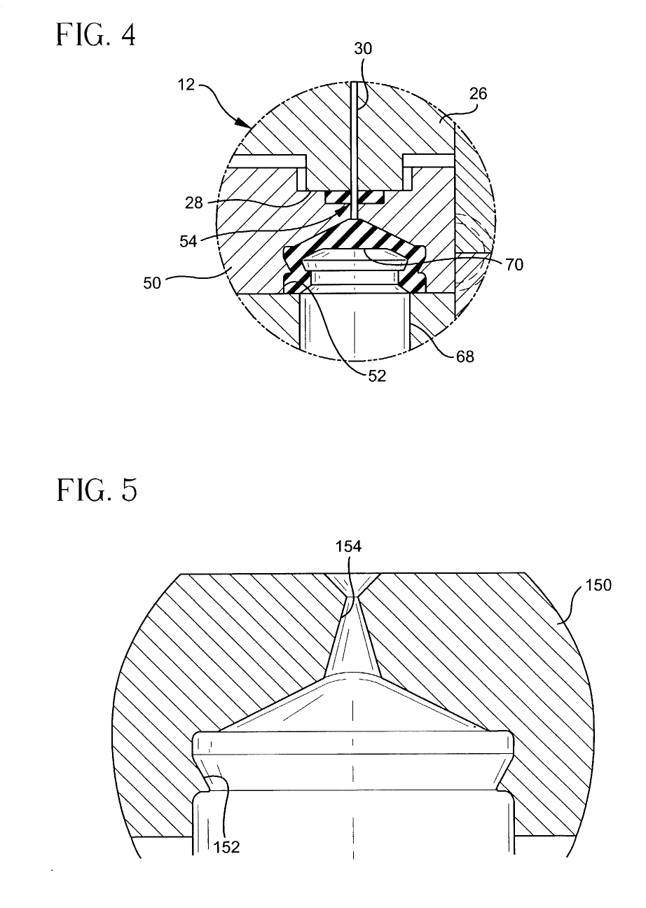

With reference to FIG. 3 and 4, molding apparatus 10 provides short narrow gates 30, 54 for a direct rapid flow of thermoplastic elastomer from hot pot 32 to the respective cavities 52. Separate sprue plates with complex arrays of runners and sprues are not provided. Gates 32 and 54 are made small to increase shear and reduce viscosity. By allowing a rapid flow of the thermoplastic elastomer into cavities 52 through small gates 32 and 52, shear is maximized and viscosity is minimized. The cross-sectional dimensions and shapes of gates 32 and 54 are selected to achieve a freeze off of the gate as close as possible to the interface between the respective cavity 52 and the corresponding gate 54 in cavity insert 50. Thus, the molded stopper or other such product can be stripped from the respective cavity 52 with a clean break that requires little or no trimming. A small plug of solidified thermoplastic elastomer may remain in gate 54 of cavity insert 50. However, this remaining solidified plug is very small and will merely be urged into the respective cavity 52 during the next molding cycle and will be surrounded by a unitary matrix of thermoplastic elastomer. Thus, any such remaining plug will become a unitary part of the next stopper to be molded. The cavities and cavity gates may take other configurations. For example, FIG. 5 shows a cavity plate insert 150 with cavities 152 and gates 154. The shape of the gate 154 is selected in view of the type of thermoplastic elastomer, the temperatures and pressure to achieve a desire freeze of location.

Molding the apparatus 10 enables a very high efficiency. In particular, the thermoplastic elastomer cures at a much faster rate than rubber that had been used most commonly in small stoppers for medical applications. Second, the subject apparatus avoids the need for complex arrays of runners and sprues to deliver material to mold cavities 52. This substantially minimizes tooling costs and enables a greater cavitation or cavity density. Third, the apparatus 10 substantially minimizes or eliminates trimming and other secondary operations, thereby leading to greater efficiencies and avoids or simplifies the cleaning operations required to ensure that debris is not present and in contact with any fluid to be stored in a syringe, tube or the like.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A hydrostatic injection molding apparatus, said apparatus comprising:
a hot transfer pot having a transfer chamber for receiving a molten thermoplastic material, said hot transfer pot having a plurality of gate openings extending therethrough and communicating with said transfer chamber, heating means provided in said hot transfer pot for maintaining said thermoplastic material in a molten state; and
a cavity plate having a hot pot mating surface configured for mating face-to-face engagement with said cavity mating surface of said hot pot plate, said cavity plate further including a support surface facing away from said hot pot plate, a plurality of cavities extending into said support surface of the cavity plate, said cavities being substantially aligned with said gates of said hot pot plate, cavity gates extending from said respective cavities to said gates of said hot pot plate for providing communication between said gates of said hot pot plate and said cavities, said cavity plate including means for cooling said thermoplastic material injected from said transfer chamber to said cavities.

2. The apparatus of claim 1, further comprising a base plate in face to face engagement with said support surface of said cavity plate for closing the respective cavities and retaining said thermoplastic material therein.

3. The apparatus of claim 2, wherein said base plate comprises cooling means for cooling said thermoplastic material in said cavities.

4. The apparatus of claim 3, wherein said cooling means of said cavity plate and said base plate each comprise channels for accommodating a flow of cooling water.

5. The apparatus of claim 2, wherein said base plate further comprises a plurality of stripper rods projecting into said respective cavities, said stripper rods being engageable with said thermoplastic material injected into said respective cavities and enabling removal of said thermoplastic material from the cavities after curing.

6. A method for manufacturing stoppers for syringes and stoppers for tubes, said method comprising:
providing a hot pot plate with a transfer chamber formed therein and transfer gates extending from said transfer chamber;
providing a cavity plate adjacent the hot pot plate, the cavity plate having cavities formed therein;
placing a molten thermoplastic material in said transfer chamber;
heating said hot pot plate sufficiently for maintaining said thermoplastic material in said transfer chamber in a molten state;
urging said molten thermoplastic material from said hot pot plate, through said transfer gates and into said cavities formed in said cavity plate; and
cooling said cavity plate to solidify said molten thermoplastic material.

7. The method of claim 6, wherein said cavity plate, said cavity plate comprises a plurality of cavity gates extending from the transfer gates to the respective cavities, the heating of said transfer pot plate and the cooling of said cavity plate being conducted to define a transition between the molten thermoplastic material and the cured thermoplastic material at locations in said gates of said cavity plate.
